(19) United States
(12) Patent Application Publication
(10) Pub. No.: US 2005/0107562 A1
(43) Pub. Date: May 19, 2005

(54) Thermoplastic polyurethanes based on aliphatic isocyanates

(75) Inventors: Marcus Leberfinger, Georgsmarienhuette (DE); Guenter Scholz, Lemfoerde (DE); Stefan Arenz, Osnabrueck (DE); Johann Diedrich Brand, Lemfoerde (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft

(21) Appl. No.: 10/497,547

(22) PCT Filed: Dec. 12, 2002
(86) PCT No.: PCT/EP02/14114

(30) Foreign Application Priority Data
Dec. 18, 2001 (DE) 101 62 349.6

(51) Int. Cl. C08G 18/00

(52) U.S. Cl. 528/44

(57) ABSTRACT

The invention provides a process for preparing thermoplastic polyurethanes by reacting a) polyisocyanates with b) compounds having at least two hydrogen atoms which are reactive toward isocyanate groups, wherein at least one monofunctional compound which is reactive toward isocyanates or/and at least one monofunctional isocyanate is added to the starting materials, the reaction mixture and/or the finished thermoplastic polyurethane.

The present invention relates to thermoplastic polyurethanes based on the reaction of (a) aliphatic diisocyanates with (b) compounds which are reactive toward isocyanates and have a molecular weight of from 500 to 8 000 and, if desired, (c) chain extenders having a molecular weight of from 60 to 499 and to the targeted setting of the flow behavior or the MFR (melt flow rate) of the thermoplastic polyurethanes. Furthermore, the invention relates to a process for preparing these thermoplastic polyurethanes and to their use.

Thermoplastic polyurethanes, hereinafter also referred to as TPUs, and processes for preparing them are generally known and have been described widely. These TPUs are partially crystalline materials and belong to the class of thermoplastic elastomers. They have, inter alia, good strength, abrasion resistance, tear propagation resistance and resistance to chemicals, and can be prepared in virtually any hardness by means of an appropriate raw materials composition. In addition, TPUs have the advantage of inexpensive preparation, for example using the belt process or the reaction extruder process which can be carried out continuously or batchwise, and simple thermoplastic processing.

DE-A 197 57 569 discloses aliphatic, emission-free, sinterable thermoplastic polyurethane molding compositions which are prepared exclusively from linear, aliphatic components.

In EP 0414060 (page 5; line 36), aliphatic TPUs based on hexamethylene diisocyanate, ethanediol butanediol adipates and hexanediol are said to be commercially available. Such TPUs are also described in JP 6-116 355, JP 7-316 254, EP 1 010 712 and EP 1 043 349. Here, it is said that these TPUs do not tend to form deposits or suffer from efflorescence.

TPUs based on, in particular, aliphatic isocyanates have the additional advantage of particularly good light fastness. These aliphatic TPUs are increasingly being used in the production of light-stable and colorfast shaped parts such as injection-molded parts of any shape, films, hoses, cables or sintered films, for example surfaces of instrument panels. Particularly for use as continuous film on dashboards behind which airbags are located, the materials have to display good material properties especially at high temperatures and on exposure to strong solar radiation.

Here, the airbag can be covered by a visible airbag flap or be located out of sight behind the instrument panel.

Powders of thermoplastic elastomers are also used for thermoplastic coating of surfaces (hereinafter referred to as the powder coating process), for example for coating steel sheet, iron, aluminum, galvanized iron, castings, pipes, profiles, wood, surfaces of plastics, ceramic, stone, concrete or other inorganic and textile surfaces, as is described, for example, in the Kunststoff Handbuch, Volume 10 (Becker/Braun; Carl Hanser Verlag), in Paints, Coatings and Solvents (Staoye, D.; Freitag, W.; Verlag Wiley-VCH) or in Powder Coatings in Europe (Streitberger, H. J.; Modern Paint Coatings; October 2000; 32-36). TPUs are not described for the coating of such surfaces.

EP 1 043 349 and EP 1 010 712 describe TPUs which are prepared at an index of 0.98 or 0.99. The index is defined as the ratio of the mole fraction of the isocyanate to the mole fraction of all compounds which are reactive toward isocyanates. A maximum molecular weight of the resulting TPU and the good mechanical properties associated therewith are achieved by the use of equimolar proportions of isocyanate and compounds which are reactive toward isocyanate. This means an index of 1.0. However, a maximum or high molecular weight is also associated with a low MFR, i.e. a high viscosity. This is a disadvantage for use in the powder slush process or the powder coating process. The powder slush process is a type of thermoplastic processing which, in contrast to extrusion or injection molding, involves no introduction of shear. The flow behavior of the TPU is therefore decisive. For this reason, indices of less than 1.0 were selected in the examples of EP 1 043 349 and EP 1 010 712.

However, these aliphatic TPUs having indices of less than 1.0 usually have an unsatisfactory rubbing resistance, as can be determined, for example, in accordance with the VW standard PV3906, or are sensitive to scratching (fingernail test). Mention is also made of the writing sensitivity.

It is an object of the present invention to improve the rubbing resistance, scratch resistance and writing sensitivity of TPUs, in particular for use in visible surfaces in automobile interiors, while nevertheless maintaining the flowability and thus satisfactory processing by the powder slush process or generally by sintering processes for coating surfaces (powder coating).

We have found that this object is achieved by preparing the TPUs at an index of about 1.0 in such a way that they nevertheless have excellent flow properties and can therefore be readily processed by sintering in the powder slush process. These excellent flow properties were able to be achieved by the use of monofunctional compounds which are reactive toward isocyanates or/and the use of monofunctional isocyanates. In both cases, the compounds are chain regulators which limit the molecular weight during the polyaddition.

The present invention provides TPUs which can be prepared by reacting
a) polyisocyanates with
b) compounds having at least two hydrogen atoms which are reactive toward isocyanate groups,
   wherein the TPUs comprise at least one monofunctional compound which is reactive toward isocyanates or/and at least one monofunctional isocyanate.

Furthermore, the invention provides a process for preparing TPUs by reacting
a) polyisocyanates with
b) compounds having at least two hydrogen atoms which are reactive toward isocyanate groups,
   wherein at least one monofunctional compound which is reactive toward isocyanates or/and at least one monofunctional isocyanate is added to the starting materials, the reaction mixture and/or the finished TPU.

The TPUs of the present invention are preferably prepared at an index in the range from 0.95 to 1.05, in particular from 0.98 to 1.02, particularly preferably 1.0. As indicated above, the index is the molar ratio of isocyanate groups to the groups which are reactive toward isocyanate.

The invention further provides for the use of the TPUs of the invention for the interior furnishing of motor vehicles by the powder slush process and for coating surfaces by the powder coating process.

The invention also provides for the use of at least one monofunctional compound which is reactive toward isocyanates or/and at least one monofunctional isocyanate for the targeted setting of the flow behavior.

The TPUs of the present invention have a melt flow index MFR determined in accordance with DIN ISO 1133 in the range from 10 to 100 at 180° C./21.6 kg and in the range from 20 to 340 at 190° C./216 kg.

The monofunctional compounds which are reactive toward isocyanates or/and the monofunctional isocyanates are used in such an amount that the combination of optimal melting behavior and high rubbing resistance of the TPU is ensured. They are preferably used in amounts of 0.01-5% by weight, preferably 0.1-2% by weight and particularly preferably in amounts of 0.2-1% by weight, based on the weight of all reaction components used in the preparation of the TPU. The isocyanate-reactive groups of the monofunctional compounds can be, for example, amino or hydroxyl groups. The molecular weight of the monofunctional compounds which are reactive toward isocyanates can be in a range from 32 to 6 000. The relatively high molecular weight, monofunctional compounds which are reactive toward isocyanates, i.e. those having a molecular weight of >500, can be monofunctional polyether monools, polyester monools or polycarbonate monools, whose corresponding diols are otherwise used as bifunctional polyol component.

The monofunctional isocyanates usually have molecular weights in the range 57-6 000. The relatively high molecular weight, monofunctional isocyanates, in particular those having a molecular weight of >600, can be monofunctional NCO prepolymers obtainable by reacting diisocyanates, monoisocyanates and polyether polyols, polyester polyols and/or polycarbonate polyols.

The preparation of the TPUs of the present invention is, as indicated above, carried out by a known method by reacting (a) diisocyanates, in particular aliphatic diisocyanates, with (b) compounds which are reactive toward isocyanates, in the presence or absence of (c) catalysts and/or (d) customary auxiliaries and of monofunctional compounds which are reactive toward isocyanates as are used according to the present invention or/and monofunctional isocyanates. As components (a) and (b), preference is given to using exclusively aliphatic and/or cycloaliphatic compounds.

The compounds b) which are reactive toward isocyanates include polyols having a molecular weight of from 500 to 8 000 and, if desired, chain extenders having a molecular weight of from 60 to 499.

To adjust the hardness of the TPUs, the amounts of the polyols having a molecular weight of from 500 to 8 000 and the chain extenders having a molecular weight of from 60 to 499 can be varied within a relatively broad range of molar ratios. Molar ratios of polyol to total chain extenders of from 1:0.5 to 1:8, in particular from 1:1 to 1:4, have been found to be useful, with the hardness of the TPUs increasing with increasing content of chain extenders.

The reaction can, as stated, be carried out at an index of 0.95-1.05:1, preferably at an index of 0.98-1.02:1 and particularly preferably 1.0. The index is defined as the ratio of the total isocyanate groups of the component (a) used in the reaction to the isocyanate-reactive groups, i.e. the active hydrogens, of the component (b) and of the functional groups of the monofunctional compounds.

The thermoplastic polyurethanes are usually prepared by known methods by the one-shot or prepolymer process on a belt unit or by means of reaction extruders. Here, the components to be reacted are combined altogether or in a particular order and reacted.

In the reaction extruder process, the formative components (a), (b) and, if used, (c) and/or (d) are introduced individually or as a mixture into the extruder and reacted at usually from 100 to 250° C., preferably from 140 to 220° C., the TPU obtained is extruded, cooled and granulated.

The processing of the TPUs of the present invention, which are usually in the form of granules or in powder form obtained by cold milling, to produce the desired plastic parts or films can be carried out, for example, by generally known extrusion, by customary injection molding or, particularly in the case of films, by the known sintering process or by sinter coating of surfaces by the powder coating process.

This preferred sintering process for preparing TPU films is usually carried out by comminuting the thermoplastic polyurethanes after reaction of the components (a) and (b) in the presence or absence of (c) and/or (d) to a particle size of from 50 to 1 000 μm, preferably from 50 to 800 μm, particularly preferably from 100 to 500 μm, and processing the comminuted thermoplastic polyurethanes at from 160 to 280° C. to produce the desired products. The TPU can be colored prior to milling, preferably by compounding with a color masterbatch. Comminution is preferably carried out by cold milling. During or after milling, additives such as powder flowability aids can be added to the TPU powder. In this preferred sintering process, also known as powder slush process, the TPU can be applied to the surface of a mold heated to from 160 to 280° C., preferably from 190 to 250° C., in an amount sufficient for the desired film thickness and melted thereon, with excess TPU powder being able to be removed again. The TPU powders melt on the heated and preferably heatable surface to give the desired films, and can, for example, be taken off after cooling of the mold. Such films are particularly suited to backfoaming with polyurethane foams and are employed, as indicated above, especially in automobile construction, for example as surfaces of instrument panels or side components of doors. The surfaces are often textured and have a leather-like structure in terms of feel and appearance. The powder flowability aids mentioned are auxiliaries which are added to the TPU and are not to be confused with the auxiliaries and additives (d) which can be used in the production of the TPUs.

The TPUs can advantageously be treated with a stream of preferably inert gas, for example air or nitrogen, in particular a hot gas, prior to comminution or after comminution or milling and thus prior to processing to produce the films. Passing this gas through the TPU, for example for from 1 to 20 hours preferably at from 70 to 160° C., blows volatile substances such as cyclic products having a molecular weight of from 200 to 2 000 arising from the reaction of the components (a) and (b), in particular the isocyanates with the chain extenders, out of the thermoplastic polyurethane. This treatment achieves an additional decrease in the content of volatile compounds in the TPUs, which not only has a positive effect on the surface appearance but also has a noticeable positive effect on the fogging values. At the same time, this step can also blow out low molecular weight components which have not been formed by secondary reactions in the polyaddition but were constituents of the starting raw materials. These can be, for example, linear and cyclic oligomers of the polyol used, in particular the polyester polyol. Preference is given to blowing volatile substances out of the thermoplastic polyurethane by means of the gas prior to processing to produce films.

The ratio (index) of the isocyanate groups to the sum of the groups which are reactive toward isocyanates in the reaction mixture, with the functionality toward isocyanates of the groups which are reactive toward isocyanates being taken into account, is preferably in the abovementioned range. The flow behavior of the TPU can be set in a targeted manner via this index. Setting of very good and optimal flow behavior for thermoplastic processing by the powder slush process or sintering process for producing instrument panel skins or for coating surfaces can be advantageous, since in this process the material is, in contrast to extrusion or injection molding, processed without friction or introduction of shear. For this reason, particular preference is given to setting a deficiency of isocyanate, i.e. particular preference is given to using a ratio (index) of the isocyanate groups of the component (a) to the sum of the isocyanate-reactive groups of the component (b) of from 0.95 to 1.05. In this way, the melt flow index determined in accordance with DIN ISO 1133 can be set in a targeted manner. Such a powder slush process is described by way of example in EP-B 399 272, column 12, lines 22 to 47, and in DE-A 197 57 569, page 3, lines 51 to 63.

The extrusion and injection molding of TPUs are generally known and have been described widely. For the purposes of the present invention, injection-molded plastic parts include all types of components, articles and shapes which can be produced according to the present invention by means of injection molding. Injection molding can be carried out using customary units known to those skilled in the art. The processing temperatures are usually in the range from 130° C. to 230° C.

For the purposes of the present invention, the term plastic parts encompasses, for example, hoses, cable sheathing, bumper bars, automobile antennae and holders, seals at the foot of exterior mirrors, door handles and seals, seals around lights, windscreen mountings, loudspeaker covers, air vents, knobs and buttons, receptacles in doors, armrests, airbag covers, impact pots, drink holders and instrument panels. Exterior bodywork parts and components in automobile interiors are particularly preferred as plastic parts.

The present invention provides, in particular, for the use of the TPUs of the present invention for the production of surface films (instrument panel skins) in automobiles by the powder slush process and the coating of surfaces such as steel sheet, iron, aluminum, galvanized iron, castings, pipes, profiles, wood, plastic surfaces, ceramics, stone, concrete or other inorganic and textile surfaces by the powder coating process, as described at the outset.

The components (a), (b) and, if desired, (c) and/or (d) usually used in the preparation of the TPUs are described by way of example below:
a) Diisocyanates (a) used are aliphatic and/or cycloaliphatic diisocyanates, for example trimethylene, tetramethylene, pentamethylene, hexamethylene, heptamethylene and/or octamethylene diisocyanate, 2-methylpentamethylene 1,5-diisocyanate, 2-ethylbutylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, dicyclohexylmethane 4,4′-, 2,4′- and/or 2,2′-diisocyanate. Preference is given to using hexamethylene 1,6-diisocyanate (hexamethylene diisocyanate, HDI) as aliphatic diisocyanate (a). For some applications, small amounts of aromatic polyisocyanates can also be used.
b) As compounds (b) which are reactive toward isocyanates, it is possible to use generally known polyhydroxyl compounds which have molecular weights of from 500 to 8 000, preferably from 600 to 6 000, in particular from 800 to 4 000, and preferably have a mean functionality of from 1.8 to 2.6, preferably from 1.9 to 2.2, in particular 2. Examples are polyesterols, polyetherols and/or polycarbonate diols. As (b), preference is given to using polyester diols which are obtainable by reacting butanediol and hexanediol as diol with adipic acid as dicarboxylic acid, with the weight ratio of butanediol to hexanediol preferably being 2:1. Preference is also given to polytetrahydrofuran having a molecular weight of from 750 to 2 500 g/mol, preferably from 750 to 1 200 g/mol, as (b). This use of polytetrahydrofuran of the molecular weight indicated enables the material properties of the TPU at low temperatures, i.e. in the range from −50° C. to 0° C., to be significantly improved, i.e. the elasticity can be significantly increased.
   As chain extenders, it is possible to use generally known compounds, for example diamines and/or alkanediols having from 2 to 10 carbon atoms in the alkylene radical, in particular ethylene glycol and/or 1,4-butanediol and/or hexanediol and/or dioxyalkylene and/or trioxyalkylene glycols having from 3 to 8 carbon atoms in the oxyalkylene radical, preferably corresponding oligooxypropylene or polyoxypropylene glycols. Mixtures of the chain extenders can also be used. Further chain extenders which can be used are 1,4-bis(hydroxymethyl)benzene (1,4-BHMB), 1,4-bis(hydroxyethyl)benzene (1,4-BHEB) or 1,4-bis(2-hydroxyethoxy)benzene (1,4-HQEE). Preference is given to using ethylene glycol and hexanediol, particularly preferably ethylene glycol, as chain extender(s).
c) As catalysts which accelerate the reaction between the NCO groups of the diisocyanates (a) and the hydroxyl groups of the formative component (b), use is made of, for example, customary tertiary amines such as triethylamine, dimethylcyclohexylamine, N-methylmorpholine, N,N′-dimethylpiperazine, 2-(dimethylaminoethoxy)ethanol, diazabicyclo[2.2.2]octane and the like, and especially organic metal compounds such as titanic esters, iron compounds such as iron(III) acetylacetonate, tin compounds, e.g. tin diacetate, tin dilaurate or the dialkyltin salts of aliphatic carboxylic acids, e.g. dibutyltin diacetate, dibutyltin dilaurate or the like. The catalysts are usually used in amounts of from 0.0001 to 0.1 parts by weight per 100 parts by weight of polyhydroxyl compound (b).
d) Apart from catalysts, customary auxiliaries and additives (d) can also be added to the formative components. Examples which may be mentioned are surface-active substances, flame retardants, nucleating agents, lubricants and mold release agents, dyes and pigments, inhibitors, stabilizers against hydrolysis, light, heat, oxidation or discoloration, agents to combat microbial degradation, inorganic and/or organic fillers, reinforcing materials and plasticizers.

Apart from the abovementioned starting materials (a)-(d), the monofunctional compounds which are reactive toward isocyanates and used according to the present invention or/and at least one monofunctional isocyanate are employed as chain regulators to set the flow behavior in a targeted manner.

As chain regulators, it is possible to use all monofunctional isocyanate-reactive compounds of the formula R¹—X—H. Here, X is preferably NH, NR², O or S, particularly preferably NH or O and very particularly preferably O. R¹ and R² can be aromatic or aliphatic, branched and unbranched hydrocarbon radicals, in particular those having from 1 to 20 carbon atoms, which may, if desired, also contain heteroatoms such as oxygen or sulfur. Examples of such chain regulators are octanol, isooctanol, nonyl alcohol, decyl alcohol, dodecyl alcohol and stearyl alcohol. Further well-suited primary monofunctional alcohols are ethylene glycol monoalkyl ethers such as ethylene glycol monomethyl ether or ethylene glycol monoethyl ether. Examples of aromatic chain regulators are phenol and 4-nonylphenol.

Suitable monofunctional amines are primary and secondary, aliphatic and aromatic amines. Examples which may be mentioned are butylamine, hexylamine, 2-ethylhexylamine, dodecylamine, stearylamine, dibutylamine, dinonylamine, bis(2-ethylhexyl)amine and N-methylstearylamine.

Further compounds which may be used as chain regulators are all monofunctional isocyanates of the formula R—NCO which are reactive toward Zerevitinov-active compounds. R can be an aromatic or aliphatic, branched or unbranched hydrocarbon radical which may also contain other heteroatoms such as oxygen or sulfur. Examples which may be mentioned are stearyl isocyanate and phenyl isocyanate.

Further details regarding the abovementioned auxiliaries and additives may be found in the technical literature, for example the Kunststoffhandbuch, Volume 7, “Polyurethane”, Carl Hanser Verlag, Munich, 3rd Edition 1993.

All the molecular weights mentioned in the context of the present invention have the unit [g/mol] and refer to the number average molecular weight.

The advantages of the TPUs of the present invention are illustrated by the following examples.

### EXAMPLES

Preparation of the base TPU 1:

The amounts shown in tables 1 and 2 of polyol, chain extender and monoalcohol (chain regulator) were combined in a vessel with 0.5% by weight, based on the total mixture, of each of Tinuvin® 328, Tinuvin® 622LD, Irganox® 245, Elastostab® H01 and 100 ppm of tin dioctoate with stirring and preheated to 80° C. The appropriate amount of diisocyanate or a mixture of diisocyanate and monoisocyanate as shown in tables 1 and 2 was subsequently added while stirring vigorously. When the temperature of the reaction mixture had reached 110° C., the mass was poured into a dish and the reaction was completed at 80° C. for 15 hours in an oven. The fully reacted material was subsequently granulated, dried at 110° C. for 3 hours, colored black with 2% by weight, based on the polyurethane, of color masterbatch in a compounding step at 190° C. in a 20 mm single-screw extruder and, after cooling in a water bath, granulated by means of an extrudate granulator. The black granulated material was once again dried at 110° C. for 3 hours and subsequently milled while cooling with liquid nitrogen in a disc mill to give a powder having a particle size of <500 μm. The powder was then sintered on a textured laboratory powder slush tool of about A4 size to give a textured skin. The sintering temperature is shown in tables 1 and 2.

Composition of Color Masterbatch:

(Preparation in a Kneader or Extruder)

Base TPU from the examples in

| | |
|---|---|
| Tables 1 and 2 | 40.0% |
| Blanc Fixe N ® (BaSO₄) | 33.6% |
| TiO R-FC ® 5 (TiO₂) | 6.4% |
| Elftex TP ® (black pigment) | 20.0% |

Sintering Process:

A textured metal slush mold of about A4 size was preheated at the prescribed temperature for 45 minutes in a convection oven. The mold was taken from the oven and 300 g of the powder were uniformly distributed on it by shaking. The excess of powder was knocked off and the mold was placed in the oven for a further 30 seconds for after-gelling to occur. The mold was taken out, cooled under a stream of water and the sintered skin was pulled off.

TABLE 1
Use of stearyl monoisocyanate as chain regulator:

| | | | | | | MFR | | | | | | |
|---|---|---|---|---|---|---|---|---|---|---|---|---|
| | Polyol | | | | | [° C./ | Hardness | TS [N/mm²] | | | | |
| | A | EG | HDI | SMI | | kg] | [Shore A] | EB [%] | SIT | Assessment of the | | |
| Ex. | [g] | [g] | [g] | [g] | Index | [g/10 min] | Abrasion [mm³] | TPR [N/mm] | [° C.] | sintered skin | Test 1 | Test 2 |
| 1.1 | 1500 | 188.0 | 637.3 | — = 0.0% | 1.0 | 190/2.16 | 89 | 43 | 250 | No sintering possible | — | — |
| (C) | | | | | | 19 | 14 | 710 | | | | |
| | | | | | | | | 88 | | | | |
| 1.2 | 1500 | 188.0 | 631 | — = 0.0% | 0.99 | 190/2.16 | 89 | 37 | 230 | Incomplete | — | — |
| (C) | | | | | | 36 | 34 | 730 | | sintering; many holes | | |
| | | | | | | | | 67 | | | | |
| 1.3 | 1500 | 188.0 | 624.5 | — = 0.0% | 0.98 | 190/2.16 | 88 | 25 | 230 | Complete sintering | 4 | 4 |
| (C) | | | | | | 66 | 87 | 780 | | | | |
| | | | | | | | | 38 | | | | |
| 2.1 | 1500 | 187.7 | 633.0 | 11.6 = 0.5% | 1.0 | 190/2.16 | 89 | 40 | 230 | Incomplete | — | — |
| | | | | | | 38 | 17 | 680 | | sintering; many holes | | |
| | | | | | | | | 80 | | | | |
| 2.2. | 1500 | 187.3 | 187.3 | 23.2 = 1.0% | 1.0 | 190/2.16 | 89 | 31 | 230 | Complete sintering; | 1 | 2 |
| | | | | | | 92 | 23 | 710 | | smooth reverse side | | |
| | | | | | | | | 77 | | | | |
| 2.3. | 1500 | 186.9 | 186.9 | 34.7 = 1.5% | 1.0 | 190/2.16 | 89 | 23 | 230 | Complete sintering; | 2 | 2 |
| | | | | | | 162 | 33 | 860 | | smooth reverse side | | |
| | | | | | | | | 47 | | | | |
| 2.4. | 1500 | 186.5 | 186.5 | 46.1 = 2.0% | 1.0 | 190/2.16 | 88 | 15 | 220 | Complete sintering; | 3 | 3 |
| | | | | | | 313 | 58 | 820 | | smooth reverse side | | |
| | | | | | | | | 60 | | | | |
| 2.5. | 1500 | 185.8 | 185.8 | 68.9 = 2.5% | 1.0 | 190/2.16 | 88 | 12 | 210 | Complete sintering; | 3 | 4 |
| | | | | | | not measur- | 110 | 790 | | smooth reverse side | | |
| | | | | | | able | | 26 | | | | |

TABLE 2
Use of n-octanol as chain regulator:

| | | | | | | MFR | Hardness | TS [N/mm²] | | | | |
|---|---|---|---|---|---|---|---|---|---|---|---|---|
| | Polyol A | H16 | HDI | n-Octanol | | [° C./kg] | [Shore A] | EB [%] | SIT | Assessment | | |
| Ex. | [g] | [g] | [g] | [g] | Index | [g/10 min] | Abrasion [mm³] | TPR [N/mm] | [° C.] | of the sintered skin | Test 1 | Test 2 |
| 3.1. | 1000 | 148.2 | 296 | — = 0.0% | 1.0 | 180/2.16 | 90 | 28 | 240 | No sintering possible | — | — |
| (C) | | | | | | 2 | 24 | 650 | | | | |
| | | | | | | | | 69 | | | | |
| 3.2. | 1000 | 148.2 | 293 | — = 0.0% | 0.99 | 180/2.16 | 90 | 19 | 240 | No sintering possible | — | — |
| (C) | | | | | | 8 | 45 | 690 | | | | |
| | | | | | | | | 49 | | | | |
| 3.3. | 1000 | 148.2 | 290 | — = 0.0% | 0.98 | 180/2.16 | 89 | 15 | 230 | Complete sintering | 3 | 3 |
| (C) | | | | | | 24 | 77 | 730 | | | | |
| | | | | | | | | 35 | | | | |
| 3.4. | 1000 | 148.2 | 287 | — = 0.0% | 0.97 | 180/2.16 | 89 | 13 | 230 | Complete sintering | 4 | 4 |
| (C) | | | | | | 42 | 102 | 750 | | | | |
| | | | | | | | | 29 | | | | |
| 4.1. | 1000 | 148.2 | 298.5 | 3.6 = 0.25% | 1.0 | 180/2.16 | 89 | 27 | 230 | Complete sintering | 1 | 1 |
| | | | | | | 27 | 30 | 630 | | | | |
| | | | | | | | | 65 | | | | |
| 4.2. | 1000 | 148.2 | 301.2 | 8.0 = 0.55% | 1.0 | 180/2.16 | 89 | 19 | 230 | Complete sintering | 2 | 2 |
| | | | | | | 48 | 56 | 790 | | | | |
| | | | | | | | | 51 | | | | |
| 4.3. | 1000 | 148.2 | 303.6 | 11.7 = 0.8% | 1.0 | 180/2.16 | 89 | 17 | 230 | Complete sintering | 2 | 3 |
| | | | | | | 97 | 62 | 780 | | | | |
| | | | | | | | | 48 | | | | |

Legends for tables 1 and 2
Polyol A = Adipic acid/hexanediol:butanediol = 1:2; OHN = 56.8
CE = Chain extender
EG = Ethylene glycol
HDI = Hexamethylene diisocyanate
SMI = Stearyl monoisocyanate as chain regulator
MFR = Melt flow rate
MFR measurement = In accordance with DIN EN ISO 1133 after drying at 110° C. for 3 h
Index = Index (molar ratio of isocyanate [mole] to compounds which are reactive toward isocyanates)
TS = Tensile strength in accordance with DIN EN ISO 527
EB = Elongation at break in accordance with DIN EN ISO 527
TPR = Tear propagation resistance in accordance with DIN 53515
Abrasion = Abrasion in accordance with DIN 53516
SIT = Sintering temperature set in the convection oven during the powder slush process
Test 1 = Test for assessing the scratch resistance; assessment in accordance with VW standard PV3906
Test 2 = Test for assessing the rubbing resistance; assessment in accordance with VW standard PV3906
C = Comparative example
Mechanical data were determined on S2 standard bars from injection-molded 2 mm plates.

Test 1:

Description of Test for Assessing the Scratch Resistance:

| | |
|---|---|
| Test apparatus: | Zwick pendulum impact tester |
| | Model 5102.100/00 |
| | Impact hammer 4 joule |

A standard small test bar (cross-sectional area: 6×4 mm) of Elastollan® 1185A10 is fixed to the impact hammer in such a way that the cross-sectional surface of the standard small test bar just brushes over the textured TPU slush skin fixed over its entire area by means of a double-sided adhesive strip when the impact hammer is released. One brush of the standard small test bar over the surface leaves more or less strong markings on the surface which are assessed by a method based on VW standard PV3906. The velocity and the momentum with which the standard small test bar brushes across the surface is accurately predetermined by the 4 joule impact hammer and the predetermined release height.

Test 2:

Description of Test for Assessing the Rubbing Resistance:

| | |
|---|---|
| Force normal to surface during rubbing: | 30 N |
| Rubbing distance (1 stroke forward and back): | 260 mm |
| Rubbing speed | |
| (1 stroke forward and back): | 15 sec |
| Number of strokes (forward and back): | 10 |
| Standard fabric: | Scouring fabric |
| | made of cotton in |
| | accordance with |
| | DIN EN ISO 12947-1 |
| | 1996-02 |
| Contact area: | 227 mm² |
| Material of contact surface: | Elastomer 50 |
| | Shore A |
| Assessment of the surface: | by method based on |
| | VW standard PV3906 |

The cotton scouring fabric is clamped in place under the contact surface and the test is carried out using 10 strokes under the above-described conditions. The assessment of the surface is carried out by a method based on VW standard PV3906.

The examples show that the process of the present invention makes it possible to prepare thermoplastic polyurethanes which have both optimal melting behavior and a high scratch and rubbing resistance. This makes them particularly useful for the powder slush process. In particular, the TPUs of the invention can be used for producing films and panels, for example instrument panels for motor vehicles, and for surface coating by the powder coating process.

In particular, it was able to be shown that
The use of a chain regulator (monoisocyanate or monoalcohol) is significantly more effective for increasing the MFR than is lowering the index.
The use of a chain regulator (monoisocyanate or monoalcohol) for setting a particular MFR at a constant high index leads to a significantly lower deterioration in the mechanical properties than does setting of the same MFR exclusively by lowering the index.
The use of a chain regulator (monoisocyanate or monoalcohol) for setting a particular MFR at constant index leads to a significantly lower decrease in the scratch and rubbing resistance than does setting the same MFR exclusively by lowering the index.

1. A process for preparing thermoplastic polyurethanes by reacting
a) polyisocyanates with
b) compounds having at least two hydrogen atoms which are reactive toward isocyanate groups and comprising polyols having a molecular weight of from 500 to 8000,
wherein at least one monofunctional compound which is reactive toward isocyanates or/and at least one monofunctional isocyanate is added to the starting materials, the reaction mixture and/or the finished thermoplastic polyurethane.

2. A process as claimed in claim 1, wherein the reaction is carried out at an index of 0.95-1.05:1.

3. A process as claimed in claim 1, wherein the reaction is carried out at an index of 0.98-1.02:1.

4. A process as claimed in claim 1, wherein the polyisocyanates
a) are aliphatic polyisocyanates.

5. A process as claimed in claim 1, wherein the monofunctional compound which is reactive toward isocyanates or the monofunctional isocyanate is used in an amount of 0.01-5% by weight, based on the weight of all reaction components.

6. A process as claimed in claim 1, wherein the monofunctional compound which is reactive toward isocyanates or the monofunctional isocyanate is used in an amount of 0.1-2% by weight, based on the weight of all reaction components.

7. A process as claimed in claim 1, wherein the monofunctional compound which is reactive toward isocyanates or the monofunctional isocyanate is used in an amount of 0.2-1% by weight, based on the weight of all reaction components.

8. A process as claimed in claim 1, wherein the monofunctional compound which is reactive toward isocyanates contains a hydroxyl group.

9. A process as claimed in claim 1, wherein the monofunctional compound which is reactive toward isocyanates contains an amino group.

10. A process as claimed in claim 1, wherein the monofunctional isocyanate is selected from the group consisting of stearyl isocyanate and phenyl isocyanate.

11. A thermoplastic polyurethane which can be prepared by reacting
a) polyisocyanates with
b) compounds having at least two hydrogen atoms which are reactive toward isocyanate groups and comprising polyols having a molecular weight of from 500 to 8000,
wherein the TPU comprises at least one monofunctional compound which is reactive toward isocyanates or/and at least one monofunctional isocyanate.

12. A thermoplastic polyurethane as claimed in claim 11 which has a melt flow index MFR in the range from 10 to 100 at 180° C./21.6 kg and in the range from 20 to 340 at 190° C./216 kg.

13. A thermoplastic polyurethane as claimed in claim 11 which has a high rubbing resistance.

14. The use of monofunctional compounds which are reactive toward isocyanates or monofunctional isocyanates for setting the melt flow index of thermoplastic polyurethanes.

15. The use of monofunctional compounds which are reactive toward isocyanates or monofunctional isocyanates for increasing the rubbing resistance of thermoplastic polyurethanes.

16. The use of thermoplastic polyurethanes as claimed in claim 11 for producing parts by the powder slush process.

17. The use of thermoplastic polyurethanes as claimed in claim 11 for coating surfaces by the powder coating process.
